(19) United States
(12) Patent Application Publication
(10) Pub. No.: US 2022/0304788 A1
(43) Pub. Date: Sep. 29, 2022

(54) THERAPEUTIC PET PILLOW AND HARNESS

(71) Applicant: Jamie C. Miller, Richmond, VA (US)

(72) Inventor: Jamie C. Miller, Richmond, VA (US)

(21) Appl. No.: 17/806,569

(22) Filed: Jun. 13, 2022

Related U.S. Application Data
(63) Continuation of application No. 29/652,203, filed on Jun. 10, 2020, now Pat. No. D955066.

(51) Int. Cl. A61D 3/00

(52) U.S. Cl. CPC A61D 3/00; A61D 2003/003

(57) ABSTRACT

A therapeutic pet pillow and harness is disclosed that assists in maintaining a desired head elevation for a pet to assist pets with a decreased esophageal muscle motility. The therapeutic pet pillow and harness aids in upper digestive system functions my imparting the elevated head positioning during resting periods for the pet. The elevated head positioning helps to decrease the possibility of fluid collection in the esophagus resulting in regurgitation, aspiration and/or failure to thrive. The therapeutic pet pillow and harness includes a cushion having an opening dimensioned to encircle a neck of the pet with an easement between an inner circumferential aspect of the opening. The harness assembly retains the cushion to the pet. A parting line allows the cushion to be opened to facilitate placement of the therapeutic pet pillow and harness about the neck of the pet.

### CROSS-REFERENCE TO RELATED APPLICATION

This application claims the benefit of priority of U.S. patent application Ser. No. 29/652,203 filed Jun. 10, 2020, the contents of which are herein incorporated by reference.

### BACKGROUND OF THE INVENTION

The present invention relates to pet products, and more particularly to therapeutic pillows for pets, particularly dogs.

While other therapeutic products are available for pets, these products are generally intended to prevent the pet from licking or otherwise interfering with a recovering wound site, such as may be experienced after a surgical intervention or a skin irritation. These devices are intended to prevent the pet from contacting the wound site, either licking or biting at the wound as it is in a recovery or healing mode. As such these devices generally entail various inverted cone designs that are worn about the neck.

For pets with decreased esophageal muscle motility, there is a danger that the esophageal fluids may be aspirated, leading to severe complications and possibly death of the pet. Conventional therapeutic pet products do not assist with these conditions.

Some pet owners have attempted to adapt conventional travel pillows for assisting their pets with decreased esophageal muscle motility. However, these still allow the pet to tuck their muzzle, while resting, and can otherwise be ineffective in alleviating the condition.

As can be seen, there is a need for improved therapeutic pet pillow and harness.

### SUMMARY OF THE INVENTION

In one aspect of the present invention, a therapeutic device for a pet is disclosed. The therapeutic device of the pet includes a cushion having an opening dimensioned to loosely encircle a neck of the pet and support a head of the pet in a head elevated angle when the pet is in a supine position. A harness assembly is coupled with the cushion and is configured to secure the cushion to a torso of the pet.

In some embodiments, a parting line is defined in the cushion and is configured to permit an expansion of the opening to emplace the cushion about the neck of the pet.

In some embodiments, the cushion has a top end and a bottom end defined along an equatorial line.

In some embodiments, the harness assembly includes an apron that extends from a bottom end of the cushion and has a length dimensioned to extend between forelegs of the pet to a chest of the pet. A neck band extends from an aft aspect of the bottom end of the cushion along a neckline of the pet. A torso band is dimensioned to encircle the chest of the pet and couples with an aft end of the apron and a terminal end of the neck band.

In some embodiments, a sleeve is defined at an aft end of the apron and a terminal end of the neck band. The torso band is slidably received through the sleeve.

In some embodiments, the harness assembly allows the cushion to dip downward as the pet moves from an upright position and produces a rolling forward motion of a front of the cushion as the pet lays down in a supine position

In some embodiments, the cushion is a toroidal frustoconical cushion. The opening is offset from an axial centerline of the toroidal frustoconical cushion.

The toroidal frustoconical cushion has a top end and a bottom end, with an equatorial line defined between the top end and the bottom end. A top surface of the top end converges inwardly towards the opening at a reduced curvature and a reduced thickness to provide a supportive surface beneath a muzzle of the pet, when worn. A bottom surface of the bottom end converges inwardly towards the opening with an increased curvature and increased thickness, relative to the top end.

In some embodiments, the bottom end has an increased thickness at a front end thereof that is inclined to a minimum thickness at an aft end thereof.

In some embodiments, the bottom end is shaped to provide an elevation of the top end of the toroidal frustoconical cushion by an abutment against one of a torso of the pet, when in an upright, seated or standing posture, and a supporting surface, when the pet is in a supine position to support the head of the pet in the head elevated angle.

These and other features, aspects and advantages of the present invention will become better understood with reference to the following drawings, description and claims.

### BRIEF DESCRIPTION OF THE DRAWINGS

FIG. 1 is a top front perspective view of a therapeutic pet pillow and harness;

FIG. 2 is a top rear perspective view of the therapeutic pet pillow and harness;

FIG. 3 is a front elevation view of the therapeutic pet pillow and harness;

FIG. 4 is a rear elevation view of the therapeutic pet pillow and harness;

FIG. 5 is a right side elevation view of the therapeutic pet pillow and harness;

FIG. 6 is a left side elevation view of the therapeutic pet pillow and harness;

FIG. 7 is a top plan view of the therapeutic pet pillow and harness;

FIG. 8 is a bottom plan view of the therapeutic pet pillow and harness; and

FIG. 9 is a top front perspective view of the therapeutic pet pillow and harness, shown in use.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a therapeutic pet pillow and harness. The therapeutic pet pillow and harness assists in maintaining a desired head elevation for a pet to assist pets with a decreased esophageal muscle motility. The therapeutic pet pillow and harness aids in upper digestive system functions my imparting an elevated head positioning during resting periods for the pet. The elevated head positioning helps to decrease the possibility of fluid collection in the esophagus resulting in regurgitation, aspiration and/or failure to thrive.

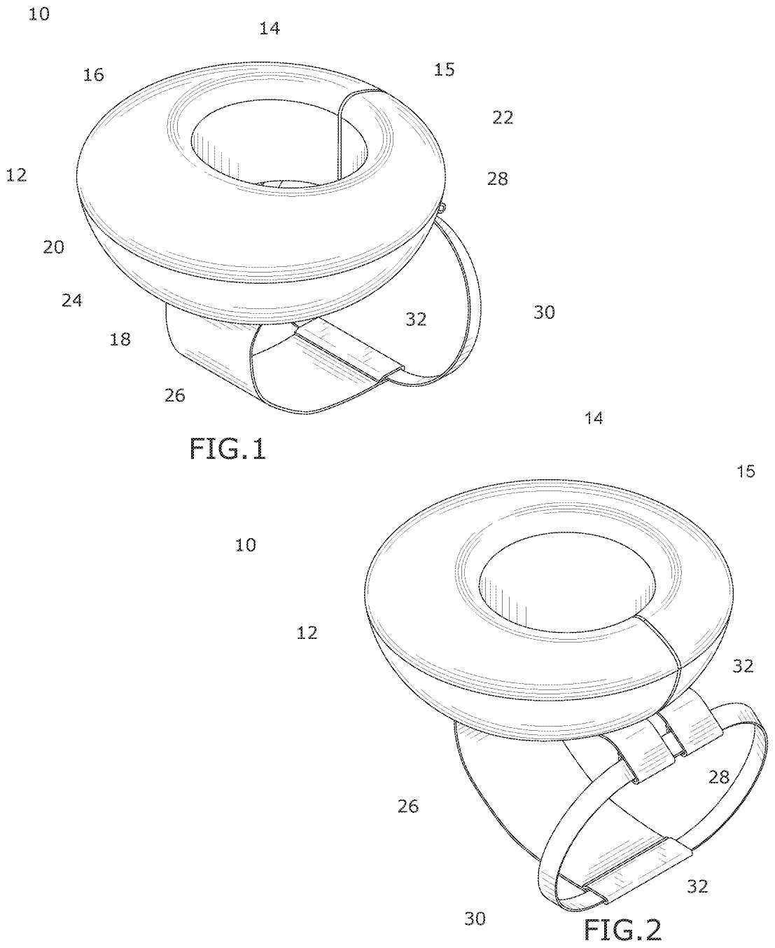

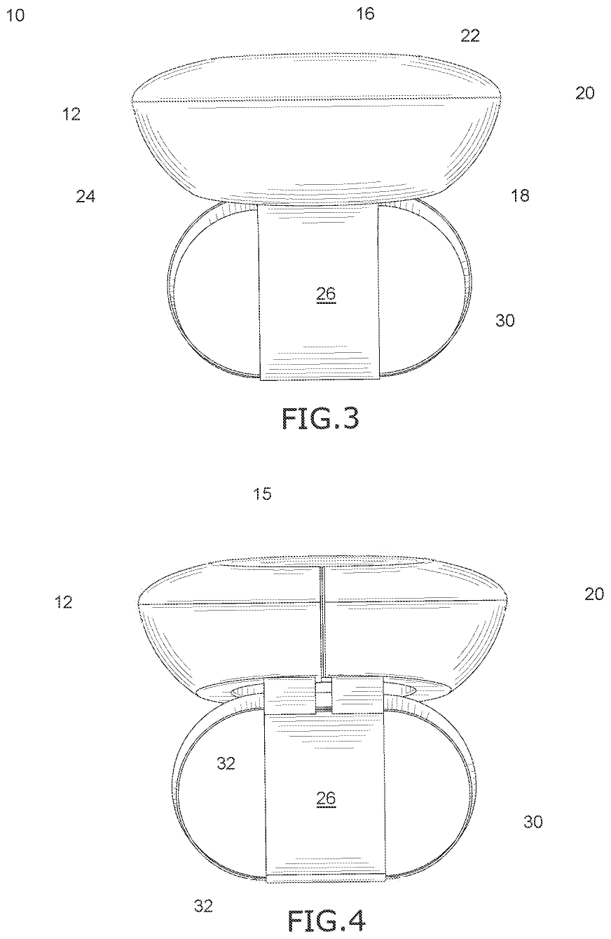

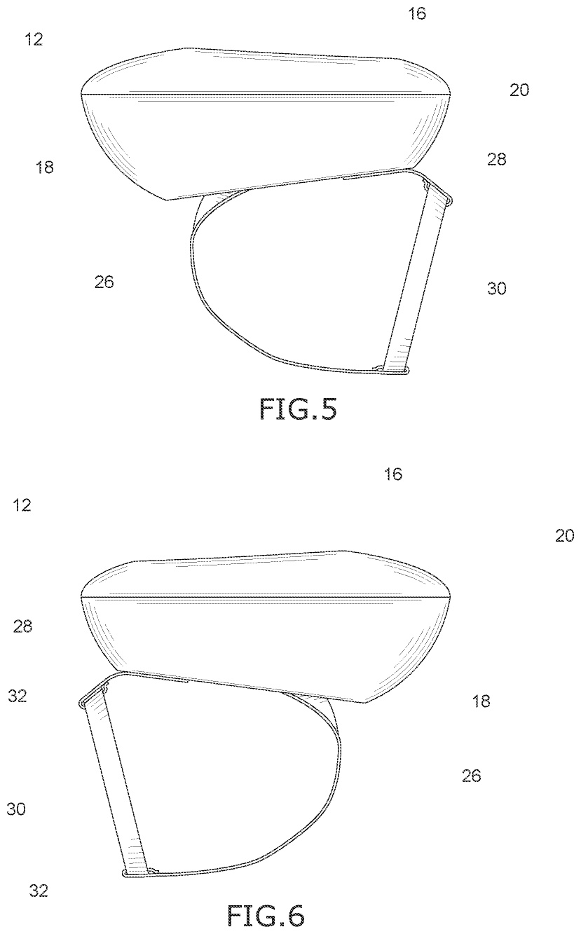

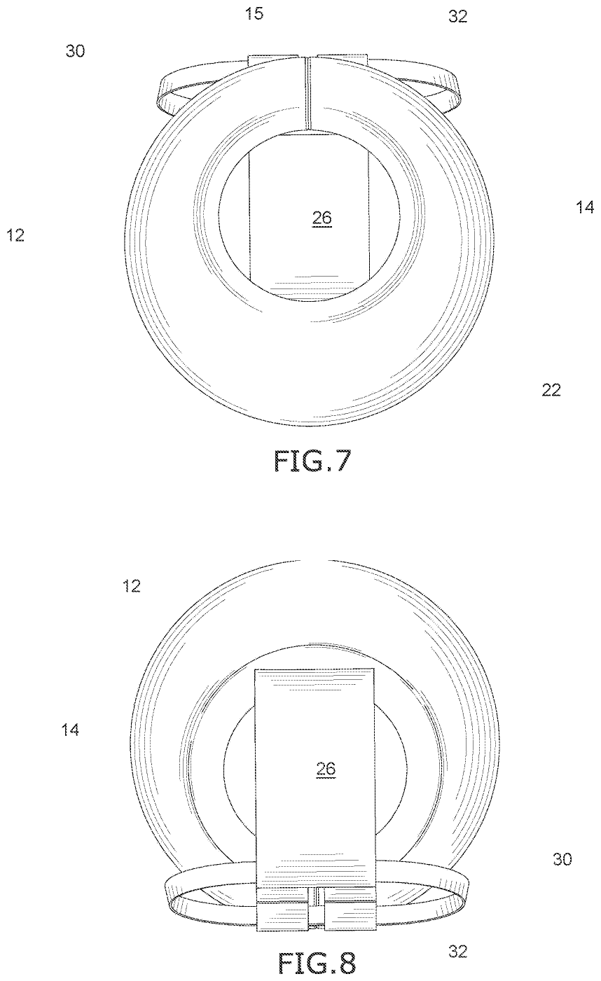

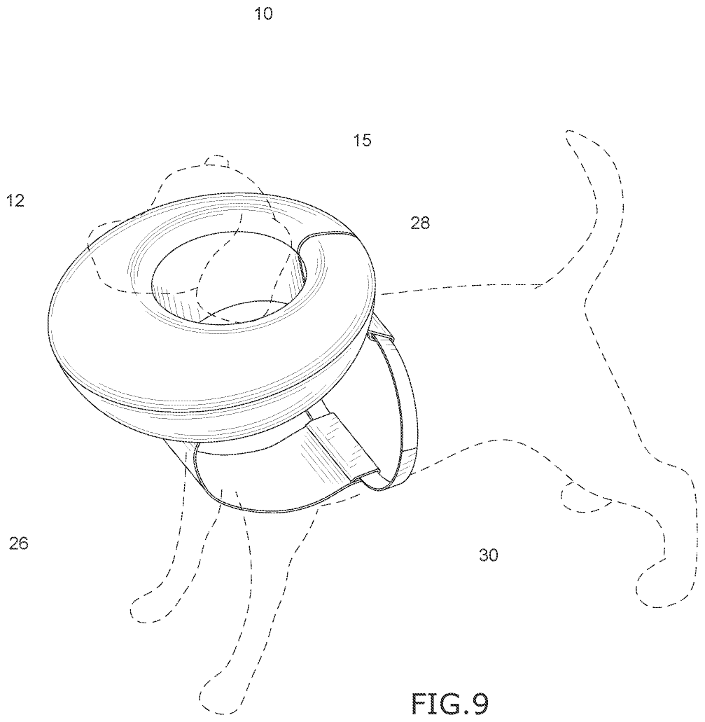

A non-limiting embodiment of the therapeutic pet pillow and harness 10 is shown in reference to the drawings of FIGS. 1-9. The therapeutic pet pillow and harness 10 includes a cushion 12 having an opening 14 dimensioned to loosely encircle a neck of the pet. A harness assembly retains the cushion 12 to the pet. A parting line 15 allows the cushion 12 to be opened to facilitate placement of the therapeutic pet pillow and harness 10 about the neck of the pet.

In the embodiment shown, the cushion 12 is a toroidal frustoconical cushion. The opening 14 is offset from an axial centerline of the toroidal frustoconical cushion 12. The toroidal frustoconical cushion 12 has a top end 16 and a bottom end 18. An equatorial line 20 separates the top end 16 from the bottom end 18.

A top surface 22 of the top end 16 converges inwardly towards the opening 14 at a reduced curvature and reduced thickness to provide a supportive surface beneath a muzzle of the pet, when worn. The cushion's center front is wider and thicker than the rest of the cushion 12 and begins decreasing in width along the sides, continuing around to the back of the cushion 12 to provide greater head support/elevation during the pet's natural resting position.

A bottom surface 24 of the bottom end 20 converges inwardly towards the opening 14 with an increased curvature and increased thickness, relative to the top end 16. The bottom end 18 has an increased thickness at the front end thereof that is inclined to a minimum thickness at an aft end thereof. The bottom end 18 is shaped to provide an elevation of the top end 16 of the toroidal frustoconical cushion 12 by an abutment against one of a torso of the pet, when in an upright, seated or standing posture, and a supporting surface, such as a floor or a couch, when the pet is in a supine position to support the head of the pet in an the elevated condition.

The cushion 12 is wider and thicker at the center front, tapering in on the sides and continues around to the center back. This allows for the main focus of the pillow right where the pet needs it the most, at the center front. Tapering of the sides removes unnecessary additional overall weight of the cushion 12 which may stress the pet's neck muscles.

The opening 14 has a convex shape around a circumferential aspect of the opening 14. The convex circumferential aspect allows the cushion 12 to sit away from the pet's neck/throat area in support of the pet's esophagus. This feature also allows for a smooth head transition slightly downward should the pet regurgitate and need to void fluids. The opening is dimensioned to provide an easement, away from the neck/throat area, of between about 1″ to 5″. The easement does not allow enough room for the pet to tuck their head downward, through the opening and bypassing the cushion 12.

An apron 26 extends from a frontal aspect of the bottom end 18 and has a length to extend between the forelegs of the pet to the chest of the pet. A neck band 28 extends from an aft aspect of the bottom end 18 along a neckline of the pet. A torso band 30 is dimensioned to encircle the chest of the pet and couples with an aft end of the apron 26 and a terminal end of the neck band 28. The apron 26, neckband 28, and torso band 30 define a harness to cooperatively retain the toroidal frustoconical cushion 12 to the pet. A sleeve 32 may be provided at the aft end of the apron 26 and the terminal end of the neck band 28 so that the torso band 30 is slidably received therethrough. The torso band 30 is adjustable in length and may be joined by a cooperating fastener, such as a button, a snap, a buckle, and a hook and pile fastener, such as Velcro®. The harness assembly and shape of the cushion 12 allows the cushion 12 to dip downward as the dog moves and produces a rolling forward motion of the front of the cushion 12 as the pet lays down in a supine position. This provides continued head elevation for the pet and holds the cushion 12 down towards the pet's clavicle and not up against the pet's throat.

The harness may be constructed from a quilted cotton fabric edged with a bias tape. The torso band 28 is made out of Ponte Knit with fabric caps at each end covering the unfinished knit end and inserts into the center front quilted section and wraps around, inserting into the back two quilted sections and is Velcro closed at center back. The neckband 28 may be wider at the center, decreasing along the sides to center back opening. T

The cushion 12 may have a closure, such as a zipper or Velcro® to allow for the containment of a removable inner pillow within the cushion 12. The removable inner pillow may be stuffed with a hypo-allergenic fiberfill stuffing. Each of the harness assembly and the cushion 12 may be washable.

It should be understood, of course, that the foregoing relates to exemplary embodiments of the invention and that modifications may be made without departing from the spirit and scope of the invention as set forth in the following claims.

What is claimed is:

1. A therapeutic device for a pet, comprising:
a cushion having an opening dimensioned to encircle a neck of the pet, and support a head of the pet in a head elevated angle, when the pet is in a supine position; and
a harness assembly coupled with the cushion, the harness assembly configured to secure the cushion to a torso of the pet.

2. The therapeutic device of claim 1, further comprising:
a parting line defined in the cushion configured to permit an expansion of the opening to emplace the cushion about the neck of the pet.

3. The therapeutic device of claim 1, the cushion having a top end and a bottom end defined along an equatorial line.

4. The therapeutic device of claim 3, wherein the harness assembly comprises:
an apron extends from a bottom end of the cushion and has a length dimensioned to extend between forelegs of the pet to a chest of the pet;
a neck band extends from an aft aspect of the bottom end of the cushion along a neckline of the pet; and
a torso band is dimensioned to encircle the chest of the pet and couples with an aft end of the apron and a terminal end of the neck band.

5. The therapeutic device of claim 4, further comprising:
a sleeve defined at an aft end of the apron and a terminal end of the neck band, wherein the torso band is slidably received through the sleeve.

6. The therapeutic device of claim 1, wherein the harness assembly allows the cushion to dip downward as the pet moves from an upright position and a shape of the cushion produces a rolling forward motion of a front of the cushion as the pet lays down in a supine position.

7. The therapeutic device of claim 1, wherein the cushion is a toroidal frustoconical cushion.

8. The therapeutic device of claim 7, wherein the opening is offset from an axial centerline of the toroidal frustoconical cushion.

9. The therapeutic device of claim 8, wherein the toroidal frustoconical cushion has a top end and a bottom end, with an equatorial line defined between the top end and the bottom end;
a top surface of the top end converges inwardly towards the opening at a reduced curvature and a reduced thickness to provide a supportive surface beneath a muzzle of the pet, when worn; and
a bottom surface of the bottom end converges inwardly towards the opening with an increased curvature and increased thickness, relative to the top end.

10. The therapeutic device of claim 9, wherein the bottom end has an increased thickness at a front end thereof that is inclined to a minimum thickness at an aft end thereof.

11. The therapeutic device of claim 10, wherein the bottom end is shaped to provide an elevation of the top end of the toroidal frustoconical cushion by an abutment against one of a torso of the pet, when in an upright, seated or standing posture, and a supporting surface, when the pet is in a supine position to support the head of the pet in the head elevated angle.
